(19) United States
(12) Patent Application Publication
(10) Pub. No.: US 2018/0204700 A1
(43) Pub. Date: Jul. 19, 2018

(54) FUSE WITH CONICAL OPEN COIL FUSIBLE ELEMENT

(71) Applicant: Littelfuse, Inc., Chicago, IL (US)

(72) Inventors: Keon Mayson Brosas, Laguna (PH); Conrado de Leon, Manila (PH); Albert Enriquez, Batangas (PH)

(73) Assignee: Littelfuse, Inc., Chicago, IL (US)

(21) Appl. No.: 15/407,656

(22) Filed: Jan. 17, 2017

(51) Int. Cl. H01H 85/08; H01H 85/175; H01H 85/38; H01H 69/02

(52) U.S. Cl. CPC H01H 85/08; H01H 85/175; H01H 2085/388; H01H 69/02; H01H 85/38

(57) ABSTRACT

A fuse including a tubular fuse body defining an interior cavity, and a fusible element describing a conical helix that tapers from a first end to a second end, the first end having a diameter that is larger than a diameter of the second end, wherein the first end of the fusible element abuts an end face of the fuse body with a portion of the fusible element extending into the interior cavity.

### FIELD OF THE DISCLOSURE

The present disclosure relates generally to the field of circuit protection devices, and relates more particularly to a fuse having a conical, open coil fuse element that is resistant to collapse and compression and that is adapted to be filled with an arc quenching material.

### FIELD OF THE DISCLOSURE

Fuses are commonly used as circuit protection devices and are typically installed between a source of electrical power and a component in a circuit that is to be protected. One type of fuse, commonly referred to as a “cartridge fuse” or “tube fuse,” includes a tubular, electrically insulating fuse body containing a fusible element that extends between electrically conductive, metallic endcaps that cover opposing longitudinal ends of the fuse body. Upon the occurrence of a specified fault condition, such as an overcurrent condition, the fusible element melts or otherwise separates to interrupt the flow of electrical current between the electrical power source and the protected component.

One type of fusible element that is commonly used in tube fuses includes a coiled fusible conductor (e.g., a coil of silver wire) that is wound about a non-conductive core (e.g. a length of glass fiber). A coiled fusible conductor may provide greater electrical resistance and greater thermal loading relative to a segment of straight, uncoiled fuse wire of the same axial length. By increasing or decreasing the density of the coiled fusible conductor (i.e., the number of turns per unit length in the coil) the electrical resistance and thermal loading of the coiled fusible conductor can be selectively varied.

Coiled fusible conductors, like most other fusible elements, are susceptible to electrical arcing that may occur immediately after separation (“blowing”) of a conductor during an overcurrent condition. In order to minimize the detrimental effects of electrical arcing, fuses are often filled with “arc-quenching materials” that surround a fusible element. Arc-quenching materials are materials that rapidly quench electrical arcs in order to mitigate arc propagation. A material that is commonly used as an arc-quenching material is sand. Sand acts as a heat absorber as its phase changes from solid to liquid when exposed to heat generated by an electrical arc. Thus, by quickly drawing heat away from an electrical arc, sand cools and eventually quenches the arc.

A shortcoming associated with the use of an arc-quenching material in conjunction with a coiled fusible conductor is that the non-conductive core about which the conductor is wound prevents the arc-quenching material from filling and engaging the interior of the coiled conductor. Additionally, the conductor and the core take up a great deal of space within a fuse, leaving very little room for an effective quantity of arc-quenching material. Both of these factors reduce the efficacy of the arc-quenching material in mitigating electrical arcing.

In an effort to overcome the above-described shortcomings, fuse elements have been developed that include a coiled fusible conductor wound about a soluble, non-conductive core (e.g., soluble yarn) that is dissolved after installation of the fusible element, thereby allowing arc-quenching material to fill the interior of the coiled conductor. However, it has been found that the weight of the arc-quenching material may cause the unsupported conductor to bend or skew out of axial alignment within a fuse body, and may also cause the coils of the conductor to be compressed. Both of these phenomena may have an unpredictable, undesirable effect on the electrical conductivity and breaking capacity of the coiled conductor.

It is with respect to these and other considerations that the present improvements may be useful.

### SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

An exemplary embodiment of a fuse in accordance with the present disclosure may include a tubular fuse body defining an interior cavity, and a fusible element describing a conical helix having that tapers from a first end to a second end, the first end having a diameter that is larger than a diameter of the second end, wherein the large end of the fusible element abuts an end face of the fuse body with a portion of the fusible element extending into the interior cavity.

An exemplary embodiment of a fusible element in accordance with the present disclosure may include a length of electrically conductive material describing a conical helix having that tapers from a first end to a second end, the first end having a diameter that is larger than a diameter of the second end.

An exemplary embodiment of a method for manufacturing a fuse in accordance with the present disclosure may include providing a tubular fuse body defining an interior cavity, and inserting a fusible element into the interior cavity, the fusible element describing a conical helix having that tapers from a first end to a second end, the first end having a diameter that is larger than a diameter of the second end, wherein the first end of the fusible element abuts an end face of the fuse body with a portion of the fusible element extending into the interior cavity.

### BRIEF DESCRIPTION OF THE DRAWINGS

FIG. 1a is a cross sectional view illustrating an exemplary fuse having an open-coil fusible element in accordance with the present disclosure;

FIG. 1b is an exploded view illustrating the fuse shown in FIG. 1a;

FIG. 2 is a flow diagram illustrating an exemplary method of manufacturing the fuse shown in FIGS. 1a-1b in accordance with the present disclosure.

### DETAILED DESCRIPTION

Embodiments of a fuse having a conical, open-coil fusible element and a method for manufacturing the same in accordance with the present disclosure will now be described more fully with reference to the accompanying drawings, in which preferred embodiments of the present disclosure are presented. The fuse and the accompanying method of the present disclosure may, however, be embodied in many different forms and should not be construed as being limited to the embodiments set forth herein. Rather, these embodiments are provided so that this disclosure will be thorough and complete, and will fully convey the scope of the fuse and the accompanying method to those skilled in the art. In the drawings, like numbers refer to like elements throughout unless otherwise noted.

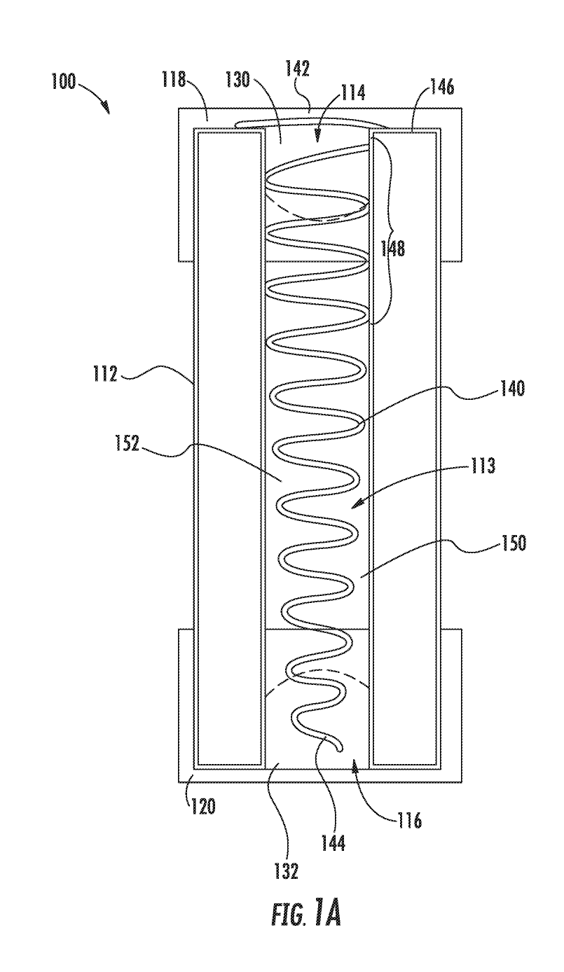

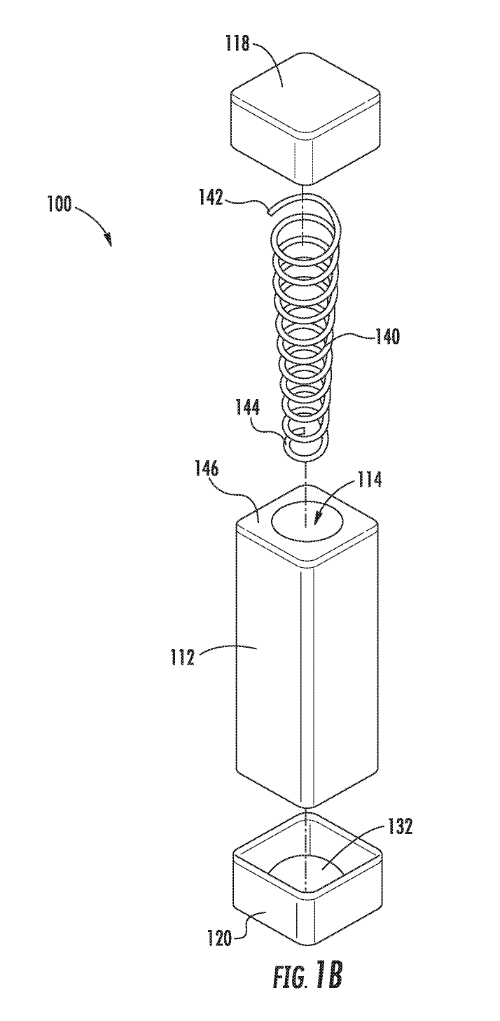

Referring to FIGS. 1a and 1b, a cut-away view and an exploded view of a fuse 100 in accordance with an exemplary embodiment of the present disclosure are shown, respectively. The fuse 100 may include a fuse body 112 that defines a hollow interior cavity 113 having opposing open ends 114, 116. The fuse body 112 may be a square cylinder (as shown in FIG. 1b), but this is not critical. Alternative embodiments of the fuse 100 may have a fuse body that is a round cylinder, an oval cylinder, a triangular cylinder, etc. The fuse body 112 may be formed of an electrically insulating material, including, but not limited to, ceramic or glass.

A pair of conductive endcaps 118, 120 may fit over the ends of the fuse body 112 and may be fastened thereto by solder fillets 130, 132 as further described below. In other embodiments, various adhesives or mechanical devices or arrangements may additionally or alternatively be implemented for securing the endcaps 118, 120 to the fuse body 112. The endcaps 118, 120 may be formed of an electrically conductive material, including, but not limited to, copper or one of its alloys, and may be plated with nickel or other conductive, corrosion resistant coatings.

A fusible element 140 may extend through the interior cavity 113 of the fuse body 112 and may be secured to the endcaps 118, 120 in electrical communication therewith by the solder fillets 130, 132. The fusible element 140 may be a generally conical, open coil having the shape of a tapered corkscrew. The shape of the fusible element 140 may also be described as a “conical helix,” or a helix having a diameter that tapers from a first, large end 142 to a second, small end 144. In various exemplary embodiments, the large end 142 may have a diameter that is 1.2 to 2 times larger than the diameter of the small end 144. In some embodiments, the fusible element 140 may taper in a linear fashion from the large end 142 to the small end 144 (e.g., as shown in FIGS. 1a and 1b). In other embodiments, the fusible element 140 may taper in a non-linear fashion from the large end 142 to the small end 144. The fusible element 140 may be formed of an electrically conductive material, including, but not limited to, tin or copper, and may be configured to melt and separate upon the occurrence of a predetermined fault condition, such as an overcurrent condition in which an amount of current exceeding a predefined maximum current flows through the fusible element 140.

The large end 142 of the fusible element 140 may have an outer diameter that is greater than a diameter of the interior cavity 113 of the fuse body 112 (as best shown in FIG. 1a). Thus, the large end 142 of the fusible element 140 may be disposed outside of the interior cavity 113 in abutment with an end face 146 of the fuse body 112, with the rest of the fusible element 140 extending into and through the interior cavity 113. The large end 142 may be sandwiched between the endcap 118 and the end face 146. A portion 148 of the fusible element 140 immediately adjacent the large end 142 may have a tapering diameter that, at its largest, is slightly smaller (e.g., 0.1 millimeters to 1 millimeter smaller) than the diameter of the interior cavity 113, and may therefore be disposed in a radially close-clearance relationship with the interior surface 150 of the fuse body 112, leaving very little room for radial displacement of the fusible element 112. When the fusible element 140 is inserted into the fuse body 112 and the large end 142 is brought into contact with the end face 146 (as further described below), the fusible element 140 may be automatically centered within the interior cavity 113 of the fuse body 112 in a substantially coaxial relationship therewith via radial engagement between the portion 148 and the interior surface 150. The fusible element 140 may thus be secured against significant axial and radial displacement relative to the fuse body 112.

Referring to FIG. 1a, the interior cavity 113 of the fuse body 112 may be partially or entirely filled with an arc-quenching material 152. The arc-quenching material 152 may be, or may include, any conventional or yet-to-be-developed arc-quenching material or composition, including, but not limited to, sand, silica, etc. that is adapted to act as a heat absorber as its phase changes from solid to liquid when exposed to heat generated by an electrical arc upon separation of the fusible element 140 (e.g., when the fuse 100 is subjected to an overcurrent condition in a circuit). Thus, by quickly drawing heat away from an electrical arc spanning separated portions of the fusible element 140, the arc-quenching material 152 rapidly cools and quenches the arc.

Advantageously, owing to the open-coil configuration of the fusible element 140, the arc-quenching material may be disposed within the fusible element 140 (i.e., radially within the interior diameter of the coil formed by the fusible element 140), in contact with substantially the entire surface of the fusible element 140 within the interior cavity 113 of the fuse 100 as shown in FIG. 1a. This is to be contrasted with coiled fusible elements that are wound around supportive, non-conductive cores (e.g., lengths of glass yarn), wherein the non-conductive cores prevent arc-quenching material from filling the interior of a coiled fusible element. Thus, relative to coiled fusible elements that are would about non-conductive cores, the coreless, open configuration of the fusible element 140 facilitates the disposition of a greater quantity of arc-quenching material in direct contact with a given length of the fusible element 140, which in-turn facilitates a greater amount of heat dissipation and more rapid arc-quenching relative to coiled fusible elements that are would about non-conductive cores.

Additionally, since the fusible element 140 is secured against significant axial and radial movement as described above, axial compression, radial shifting, and angular deflection of the fusible element 140 under the weight of arc-quenching material 152, which have been observed in fuses having conventional open-coil fusible elements, are mitigated. The conductive properties and breaking capacity of the fusible element 140 may therefore be preserved even after the arc-quenching material is disposed within the interior cavity 113 of the fuse body 112, and the fuse 100 may perform in a desired, predictable manner.

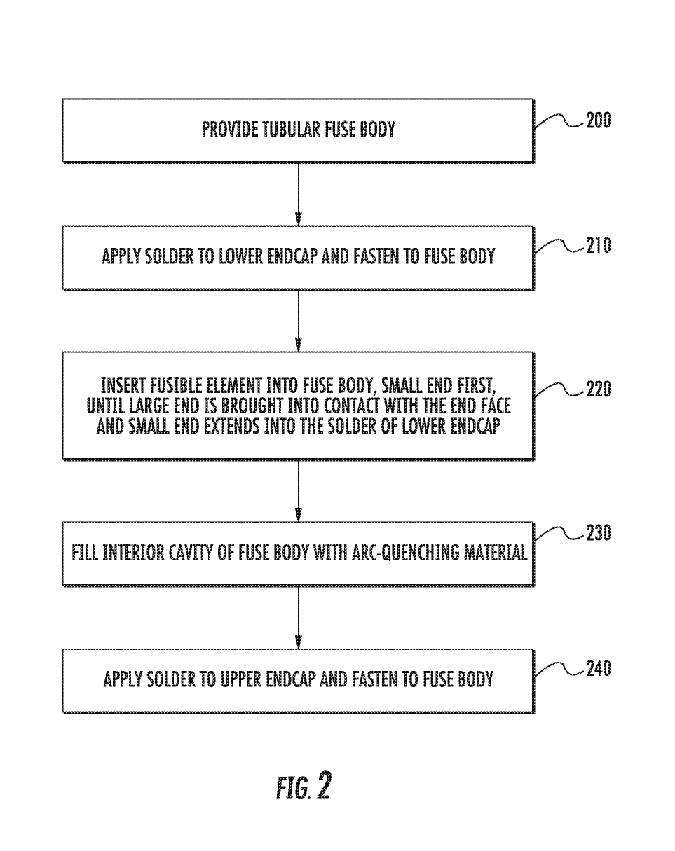

Referring to FIG. 2, a flow diagram illustrating an exemplary method for manufacturing the above-described fuse 100 in accordance with the present disclosure is shown. The method will now be described in conjunction with the illustrations of the fuse 100 shown in FIGS. 1a and 1b.

At step 200 of the exemplary method, the tubular fuse body 112 having a hollow interior cavity 113 and open ends 114, 116 may be provided. The fuse body 112 may be a square cylinder (as shown in FIG. 1b), but this is not critical. The fuse body 112 may be formed of an electrically insulating material, including, but not limited to, ceramic or glass.

At step 210 of the exemplary method, the solder fillet 132 may be applied to the endcap 120, and the endcap 120 may be fastened to the fuse body 112 over the open end 116 of the interior cavity 113 by the solder fillet 132. Additionally or alternatively, the endcap 120 may be fastened to the fuse body 112 by an adhesive and/or a mechanical fastening device/configuration.

At step 220 of the exemplary method, the fusible element 140 may be inserted, small end 144 first, into the open end 114 of the interior cavity 113 of the fuse body 112 until the large end 142 is brought into contact with the end face 146 and the small end 144 extends into the solder fillet 132 while the solder fillet 132 is still in a fluid or semi-fluid state. The fusible element 140 may thus be disposed in electrical communication with the endcap 120. As described above, the fusible element 140 may be automatically centered within the interior cavity 113 of the fuse body 112 in a substantially coaxial relationship therewith via radial engagement between the portion 148 and the interior surface 150.

At step 230 of the exemplary method, the interior cavity 113 of the fuse body 112 may be partially or entirely filled with the arc-quenching material 152. Owing to the open-coil configuration of the fusible element 140, the arc-quenching material 152 may be disposed within the fusible element 140 (i.e., within the coil formed by the fusible element 140), in contact with substantially the entire surface of the fusible element 140 that is disposed within the interior cavity 113 of the fuse 100. Since the fusible element 140 is secured against significant radial movement relative to the fuse body 112, and since engagement between the large end 142 of the fusible element 140 and the end face 146 of the fuse body 112 prevents axial movement of the fusible element into the fuse body 112, the fusible element 140 may maintain its radial, axial, and angular disposition relative to the fuse body 112 against the weight of the arc-quenching material 152.

At step 240 of the exemplary method, the solder fillet 130 may be applied to the endcap 118, and the endcap 118 may be fastened to the fuse body 112 over the open end 114 of the interior cavity 113 by the solder fillet 130 while the solder fillet 130 is still in a fluid or semi-fluid state. Additionally or alternatively, the endcap 118 may be fastened to the fuse body 112 by an adhesive and/or a mechanical fastening device/configuration. The solder fillet 130 may partially of entirely envelope the large end 142 and the portion 148 of the fusible element 140. The fusible element 140 may thus be disposed in electrical communication with the endcap 118. As described above, the large end 142 may be sandwiched between the endcap 118 and the end face 146 of the fuse body 112, thereby preventing significant axially displacement of the fusible element 140 relative to the fuse body 112.

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

While the present disclosure makes reference to certain embodiments, numerous modifications, alterations and changes to the described embodiments are possible without departing from the sphere and scope of the present disclosure, as defined in the appended claim(s). Accordingly, it is intended that the present disclosure not be limited to the described embodiments, but that it has the full scope defined by the language of the following claims, and equivalents thereof.

1. A fuse comprising:
a tubular fuse body defining an interior cavity; and
a fusible element that, in its entirely, defines the shape of a conical helix, a first end of the fusible element having a diameter that is 1.2-2 times larger than a diameter of a second end of the fusible element;
wherein the first end of the fusible element abuts an end face of the fuse body with a portion of the fusible element extending into the interior cavity;
the first end of the fusible element being soldered directly to a first endcap on a first end of the fuse body, and the second end of the fusible element being soldered directly to a second endcap on a second end of the fuse body.

2. The fuse of claim 1, wherein the fusible element tapers linearly from the first end of the fusible element to the second end of the fusible element.

3. The fuse of claim 1, wherein the fusible element tapers non-linearly from the first end of the fusible element to the second end of the fusible element.

4.-5. (canceled)

6. The fuse of claim 1, wherein the interior cavity is at least partially filled with an arc-quenching material, the arc-quenching material disposed within the fusible element, radially inward of an interior diameter of the fusible element.

7. The fuse of claim 6, wherein the arc-quenching material comprises at least one of sand and silica.

8. The fuse of claim 1, wherein a portion of the fusible element has an outer diameter that is 0.1 millimeters to 1 millimeter smaller than the diameter of the interior cavity.

9. The fuse of claim 1, wherein the first end of the fusible element is disposed outside of the interior cavity.

10. The fuse of claim 1, wherein the fusible element is coaxial with the fuse body.

11.-13. (canceled)

14. A method of manufacturing a fuse, the method comprising:
providing a tubular fuse body defining an interior cavity;
fastening a first endcap to a first end of the fuse body with a first solder fillet;
inserting a fusible element into the interior cavity, the fusible element that, in its entirety, defines the shape of a conical helix, a first end of the fusible element having a diameter that is 1.2-2 times larger than a diameter of the second end of the fusible element, wherein the first end of the fusible element abuts an end face of a second end of the fuse and the second end of the fusible element is disposed within the first solder fillet; and
fastening a second endcap to the second end of the fuse body and to the first end of the fusible element with a second solder fillet.

15. The method of claim 14, wherein the fusible element tapers linearly from the first end of the fusible element to the second end of the fusible element.

16. The method of claim 14, wherein the fusible element tapers non-linearly from the first end of the fusible element to the second end of the fusible element.

17.-18. (canceled)

19. The method of claim 14, further comprising at least partially filling the interior cavity with an arc-quenching material, the arc-quenching material filling the fusible element radially inward of an interior diameter of the fusible element.

20. The method of claim 14, wherein a portion of the fusible element has an outer diameter that is 0.1 millimeters to 1 millimeter smaller than the diameter of the interior cavity.
